(19) United States
(12) Patent Application Publication
(10) Pub. No.: US 2006/0288377 A1
(43) Pub. Date: Dec. 21, 2006

(54) Multimedia I/O interface device for airplane seat

(76) Inventor: Hsiang-Chi Hsieh, Sindian City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/452,192

(22) Filed: Jun. 14, 2006

(30) Foreign Application Priority Data
Jun. 17, 2005 (TW) 094210264

(51) Int. Cl. H04N 7/18

(52) U.S. Cl. 725/76

(57) ABSTRACT

A multimedia I/O interface device for cars is provided, including a player data bus, a player I/O interface, a microprocessor, a memory unit, a USB OTG controller, a buffer, and an MHE. The player data bus and player I/O interface are connected to a multimedia player for airplane seats. The multimedia player for airplane seats is an audiovisual player. The microprocessor controls the data input/output and the storage of the multimedia player. The USB OTG controller, the buffer, and the MHE form a USB connection and transmission interface. The multimedia I/O interface device of the present invention is a connected to a USB connector and a card reader interface through the USB OTG controller and the MHE, respectively. Therefore, the multimedia device can be connected to a multimedia storage device with a USB interface or a flash memory for bi-direction data transmission.

### BACKGROUND OF THE INVENTION

1. Field of the Invention

The present invention relates to a multimedia I/O interface device for airplane seats and, more particularly, to a multimedia I/O interface device applicable to audiovisual players used in airplane seats. The multimedia I/O interface device can be used to upload media data for playing or download media data for storing.

2. The Related Art

Airplanes are the most popular transportation vehicles for crossing a long distance, especially for international travelers. As the development of the international traveling, more and more airplanes provide in-flight audiovisual entertainment to their passengers, and many passengers now consider that a personal audiovisual entertainment an indispensable part of a long distance flight.

Conventional personal audiovisual players for airplane seats are only for playing pre-recorded media programs prepared by the airliner. Passengers can only selected from the limited selections provided by the airliner, and are not allowed to use mobile phones or sometimes notebook computers to play media programs stored on their personal multimedia devices, such as MP3 player, flash memory sticks, PDA, digital camera, recording pen, and so on. Therefore, the functions provided by audiovisual devices for airplane seat are limited, and fail to meet the standard of the multimedia entertainment for many passengers. As the multimedia devices for households and offices are rapidly developed, it is important to further the development of multimedia devices for flight passengers.

### SUMMARY OF THE INVENTION

A primary object of the present invention is to provide a multimedia I/O interface device for airplane seats, including a player data bus, a player I/O interface, a microprocessor, a memory unit, a USB OTG controller, a buffer, and an MHE. The player data bus and player I/O interface are connected to a multimedia player for airplane seats. The multimedia player for airplane seats is an audiovisual player. The microprocessor controls the data input/output and the storage of the player. The USB OTG controller, the buffer, and the MHE form a USB connection and transmission interface. The multimedia device of the present invention is connected to a USB connector and a card reader interface through the USB OTG controller and the MHE, respectively. Therefore, the multimedia I/O interface device for airplane seats of the present invention can be connected to a multimedia storage device with a USB interface or a flash memory for access.

The present invention improves the limitation experienced by conventional audiovisual players for airplane seats that can only be used for playing pre-recorded storage media. The present invention can be used with popular digital devices, such as MP3 player, flash memory stick, digital camera, recording pen, and so on. Therefore, the audiovisual data stored on these digital devices can be played on the audiovisual player for airplane seats. In addition, the audiovisual data in the audiovisual player for airplane seats can be downloaded and stored in these digital devices.

These and other objects, features and advantages of the invention will be apparent to those skilled in the art, from a reading of the following brief description of the drawings, the detailed description of the preferred embodiment, and the appended claims.

### BRIEF DESCRIPTION OF THE DRAWINGS

The present invention can be understood in more detail by reading the subsequent detailed description in conjunction with the examples and references made to the accompanying drawings, wherein:

FIG. 1 is a system block diagram of a first embodiment of the present invention;

FIG. 2 is a system block diagram of a second embodiment of the present invention;

FIG. 3 is a preferred embodiment of the application of the present invention; and

FIG. 4 is a partial enlargement of the view in FIG. 3.

### DETAILED DESCRIPTION OF THE PREFERRED EMBODIMENTS

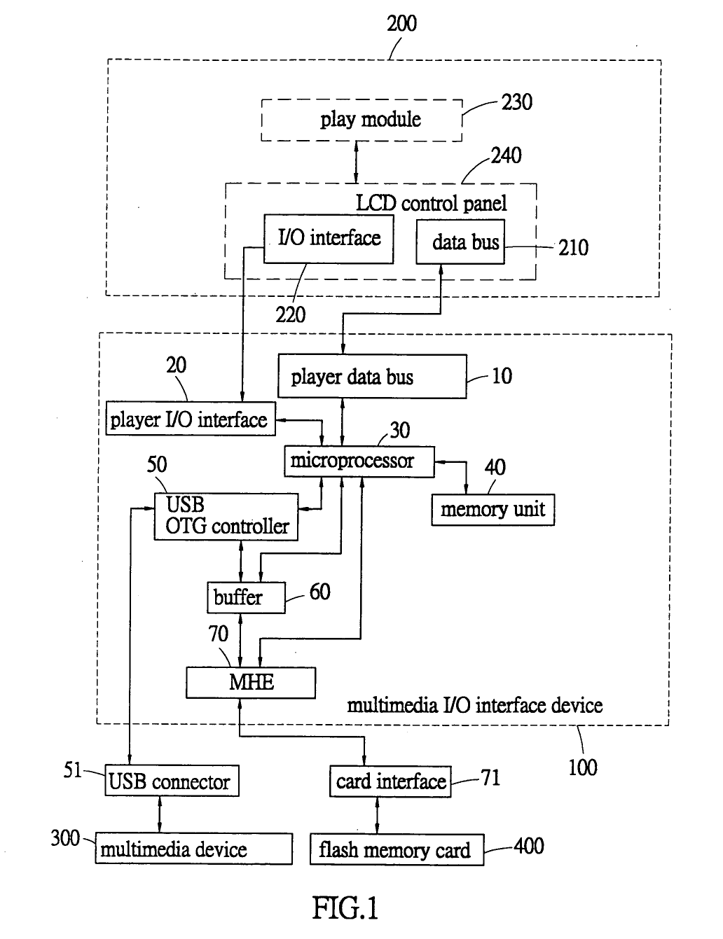

With reference to the drawings and in particular to FIG. 1, which shows a first embodiment of the present invention, a multimedia I/O interface device 100 for airplane seats includes a player data bus 10, a player I/O interface 20, a microprocessor 30, a memory unit 40, a USB OTG controller 50, a buffer 60 and an MHE 70. The player data bus 10 and the player I/O interface 20 are connected, respectively, to a data bus 210 and an I/O interface 220 of a multimedia player 200 for airplane seats. The multimedia player 200 is not limited to any specific type. The embodiment uses a DVD player as an example, but a VCD player for an audio tape player can also be used.

The multimedia player 200 includes a play module 230 and a controller 240. By inputting control instructions to the controller 240, the user can control the playing of the DVD media. The data bus 210 and the I/O interface 220 are connected to the controller 240 so that the controller 240 controls the data input/output. The control and the circuitry of the controller 240 on the data bus 210 and the I/O interface 220 are of conventional technology, and will be omitted here.

The player data bus 10 and the player I/O interface 20, through the connection to the data bus 210 and the I/O interface 20, are connected to the controller 240 of the multimedia player 200 for airplane seats for bi-directional data transmission.

The microprocessor 30 controls the transmission and storage of the media data. The microprocessor 30 is pre-installed with programs for controlling the format conversion, transmission, and storage of the media data. The microprocessor 30 is connected to the player data bus 10 and the player I/O interface 20. Through the player data bus 10 and the player I/O interface 20, the microprocessor 30 can receive data from or transmit data to the controller 240 of the multimedia player 200, which then passes on to the play module 230.

The memory unit 40 is connected to the microprocessor 30 to provide the temporary storage for the data or program on the microprocessor 30. The memory unit 40 is not limited to any specific type. This embodiment uses SDRAM as an example.

The USB OTG controller 50, the buffer 60, and the MHE 70 serially form a USB interface. The USB OTG controller 50, the buffer 60, and the MHE 70 are connected and controlled by the microprocessor 30, respectively. The USB OTG controller 50 is connected to a USB connector 51, which provides connections to a multimedia device 300 with a USB interface, such as MP3 player, flash memory stick, digital camera, recording pen, and so on. Through the USB OTG controller 50, the multimedia device 300 with a USB interface can transmit the audiovisual data, through the microprocessor 30, the player data bus 10, the player I/O interface 20, to the controller 240 of the multimedia player 200 for processing and playing. Conversely, the audiovisual data in the controller 240 of the multimedia player 200 can be downloaded and stored in the multimedia device 300 with a USB interface.

The buffer 60 provides the temporary storage to buffer data when the amount of data is large. The buffer 60 is connected the MHE 70, so that the MHE 70 becomes a card-reading interface. The MHE 70 is connected to a card interface 71, through which the connection to a flash memory card 400 is provided. The flash memory card 400 connected to the card interface 71 can transmit the audiovisual data to the play module 230 of the multimedia player 200, through the MHE 70, the microprocessor 30, the player data bus 10, and the player I/O interface 20, for playing. Alternatively, the audiovisual data stored in the flash memory card 400 connected to the card interface 71 can be uploaded, through the MHE 70, the buffer 60, the USB OTG controller 50, and the microprocessor 30, to the multimedia device 300 with a USB interface connected to the USB connector 51 for storing. Conversely, the data stored in the multimedia device 300 with a USB interface can also be transmitted to the flash memory card 400 for storing. Therefore, the bi-directional data transmission and storing between the flash memory card 400 and the multimedia device 300 with a USB interface is allowed.

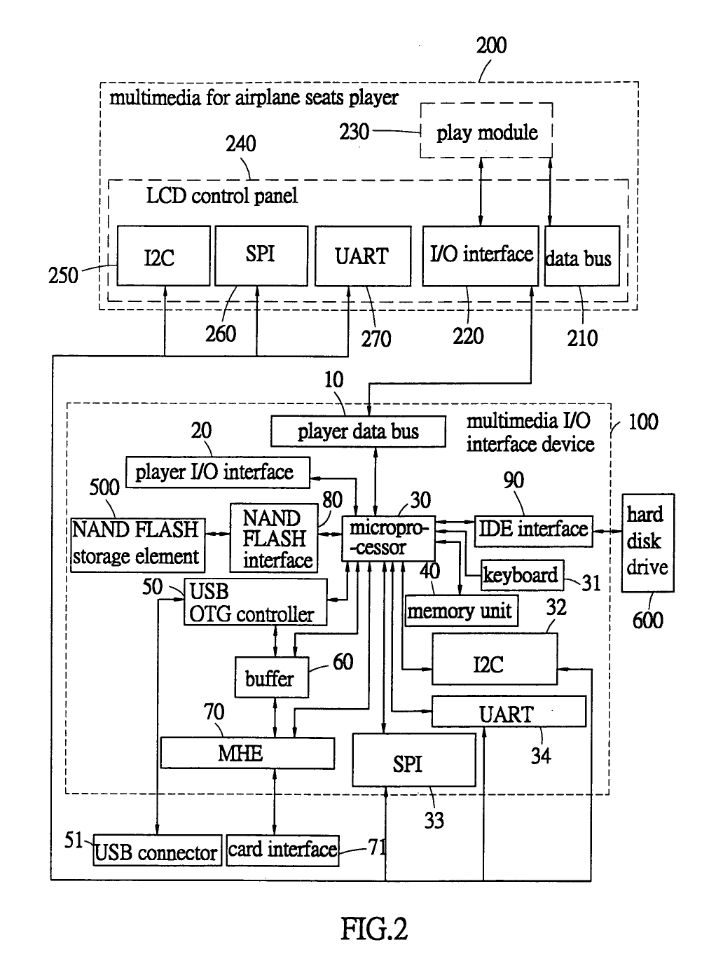

FIG. 2 shows a second embodiment of the present invention, wherein the memory unit 40 stores the image data of the fingerprints of the user. This embodiment is applied to a multimedia player 200 with a different type of I/O interface. The multimedia player 200 includes an I2C 250, an SPI 260, and an UART 270. The microprocessor 30 is connected to a keyboard 31, an 12C 32, an SPI 33, an UART 34, a NAND FLASH interface 80 and an IDE interface 90. The keyboard 31 provides the instruction input to the microprocessor 30, such as uploading for playing on the play module 230 of the multimedia player 200 or data transmission for storage between the flash memory card 400 and the multimedia device 300 with a USB interface. The keyboard 31 can be either stand alone or integrated into the controller 240 of the multimedia player 200 for airplane seats.

As shown in FIG. 2, the I2C 32, the SPI 33 and the UART 34 serially form a structure for transmission of different data type and interface. Therefore, the multimedia I/O interface device 100 of the present invention can be applied to the multimedia player 200 for airplane seats with different types of interface.

The NAND FLASH interface 80 and the IDE interface 90 provide connections to a NAND FLASH storage element 500 and a hard disk drive 600, respectively. Through the microprocessor 30 and the USB OTG controller 50, bi-directional data transmission between the flash memory card 400 connected to the card interface 71 and the multimedia devices 300 connected to the USB connector 51 can be executed. For example, the GPS map can be uploaded to a flash memory stick with the USB interface. Similarly, through the microprocessor 30, the buffer 60, the MHE 70, and the card interface 71, the bi-directional data transmission can also be performed between the NAND FLASH storage element 500, the hard disk drive 600 and the flash memory card 400 connected to card interface 71.

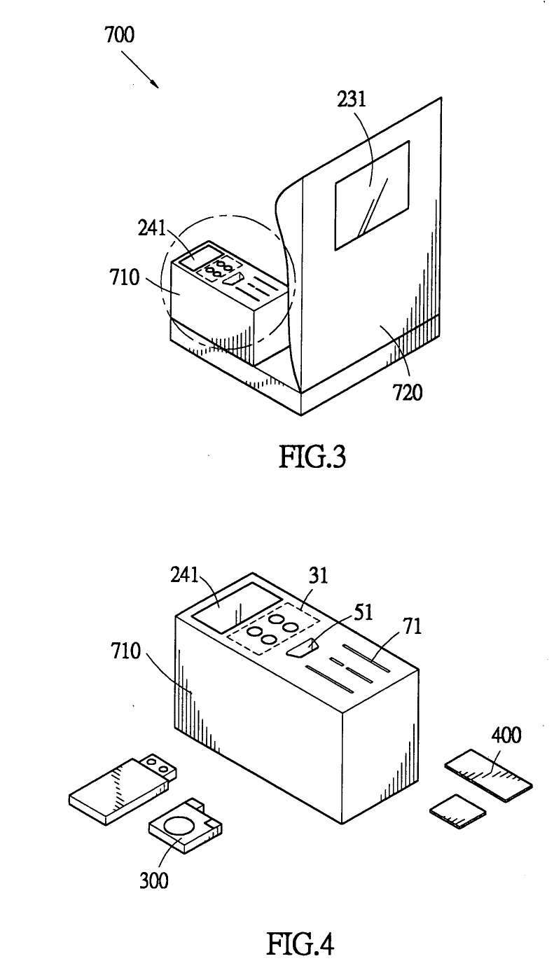

FIG. 3 shows a preferred embodiment of the application of the present invention, and FIG. 4 shows a partially enlarged view of FIG. 3. In FIG. 3, the multimedia I/O interface device 100 of the present invention is embedded in the armrest 710 of an airplane seat 700. The top surface of the armrest 710 includes a keyboard 31, a USB connector 50, and a plurality of card interfaces 71, and an LCD control panel 241. A display screen 231 is installed on the seat back 720 of the airplane seat 700. The keyboard 31 is for the user to press for transmitting data on the multimedia device 300 with a USB interface and the flash memory card 400 to the multimedia player 200 for airplane seats for playing, or for bi-directional transmission of data between the flash memory card 400 and the multimedia device 300 with a USB interface.

The card interface 71 embedded in the aforementioned armrest 710 provides connections to different types of flash memory cards, such as CF, SD, SM, MS or MMC.

The LCD control panel 241 is the display panel of the controller 240 of the multimedia player 200 for airplane seats. The LCD control panel 241 can display the operation status of the multimedia player 200 of airplane seats. The display screen 231 is the display screen of the play module 230 of the multimedia player 200 for airplane seats. The display screen 231 can play audio and visual data. The contents displayed on the display screen 231 are the contents on the multimedia player 200 operated by the passenger sitting behind.

While the invention has been described in connection with what is presently considered to the most practical and preferred embodiment, it is to be understood that the invention is not to be limited to the disclosed embodiment, but on the contrary, is intended to cover various modifications and equivalent arrangement included within the spirit and scope of the appended claims.

What is claimed is:

1. A multimedia I/O interface device for airplane seats, applicable to a multimedia player used in airplane seats, the multimedia I/O interface device comprising:
a player data bus, connected to a data bus to the multimedia player for airplane seats;
a player I/O interface, connected to an I/O interface of the multimedia player for airplane seats;
a microprocessor, connected to the player data bus and the player I/O interface, forming bi-directional data transmission connection with the multimedia player for airplane seats through the player data bus and the player I/O interface for performing format conversion, transmission and storing of data;
a memory unit, connected to the microprocessor to provide temporary storage of data and programs to the microprocessor;
a USB OTG controller, connected to the microprocessor, and connected externally to a multimedia device with an USB interface, for transmitting data from the external multimedia device to the multimedia player for airplanes seats for playing;
a buffer, connected to the microprocessor and the USB controller to provide temporary storage; and
an MHE, connected to the buffer and the microprocessor, and connected externally to a flash memory card for transmitting data on the flash memory card through the microprocessor to the multimedia player for airplane seats for playing, or through the buffer, the USB OTG controller and the microprocessor to provide bi-directional data transmission between the external flash memory card and the multimedia device with a USB interface connected to the USB OTG controller.

2. The device as claimed in claim 1, wherein the microprocessor is connected to a keyboard.

3. The device as claimed in claim 1, wherein the microprocessor is connected to an I2C, an SPI, and an UART.

4. The device as claimed in claim 1, wherein the microprocessor is connected to a NAND FLASH interface and an IDE interface.

5. The device as claimed in claim 4, wherein the NAND FLASH interface is connected to a NAND FLASH storage element.

6. The device as claimed in claim 4, wherein the IDE interface is connected to a hard disk drive.

7. The device as claimed in claim 1, wherein the memory unit is an SDRAM.

8. The device as claimed in claim 1, wherein the USB OTG controller is connected to a USB connector, the USB connector being connected to a multimedia device with a USB interface.

9. The device as claimed in claim 1, wherein the MHE is connected externally to a card interface, the card interface being connected to a flash memory card.
